(19) United States
(12) Patent Application Publication
(10) Pub. No.: US 2011/0043113 A1
(43) Pub. Date: Feb. 24, 2011

(54) FAUCET ASSEMBLY

(76) Inventors: MAO-SHENG WENG, Xianxi Township (TW); JING-YUEH WENG, Xianxi Township (TW)

Correspondence Address: Yen Jung Sung, 30-47 37 St., Astoria, NY, 11103, US

(21) Appl. No.: 12/856,583

(22) Filed: Aug. 14, 2010

(30) Foreign Application Priority Data
Aug. 19, 2009 (TW) 098215267

(51) Int. Cl. H01K 7/00

(52) U.S. Cl. 315/76

(57) ABSTRACT

A faucet assembly includes a faucet body, a power-generating device and a circuit board. The faucet body has a water channel. An accommodating chamber is provided in the water channel. An illumination port is provided below the faucet body. The power-generating device is provided in the accommodating chamber of the faucet body and has an impeller, a first magnetic element, a second magnetic element and a coil set. The impeller is connected to the first magnetic element. The second magnetic element is connected to the coil set. The first magnetic element and the second magnetic element attract each other to generate a mutual movement. The circuit board is electrically connected to the coil set of the power-generating device. The circuit board is arranged with light-emitting diodes set in the illumination port of the faucet body. With this arrangement, the faucet assembly provides enhanced illumination and a cleaning effect in a power-saving, durable and user-friendly manner.

### BACKGROUND OF THE INVENTION

1. Field of the Invention

The present invention relates to a faucet assembly, and in particular to an improved faucet assembly having a faucet body, a power-generating device and a circuit board, which is capable of providing enhanced illumination and a cleaning effect in a power-saving, durable, user-friendly manner. Therefore, the present invention can be used in a kitchen, bathroom or for other washing devices.

2. Description of the Prior Art

Water is very important for people's daily lives because they drink it every day and wash objects using water. Water is supplied from the mains and runs from a faucet. However, the conventional faucet only allows water to run and does not provide illumination. As a result, a user may not be certain whether objects such as fruits, vegetables, kitchenware or hands are washed sufficiently because the user cannot see the surfaces of the objects very clearly, especially when the ambient light is insufficient.

In view of the above-mentioned problems, the present inventor proposes an improved faucet assembly based on his research and expert knowledge.

### SUMMARY OF THE INVENTION

An objective of the present invention is to provide a faucet assembly. A power-generating device is disposed in an accommodating chamber of a faucet body. The power-generating device is electrically connected to a circuit board. The circuit board is arranged thereon with light-emitting diodes. With this arrangement, the faucet assembly of the present invention is capable of providing enhanced illumination and a cleaning effect in a power-saving, durable and user-friendly manner, thereby increasing the practicability, novelty and inventive steps thereof.

Another object of the present invention is to provide a faucet assembly. In one aspect an accommodating chamber is provided that includes an upper chamber and a lower chamber. The upper chamber is separated from the lower chamber. An impeller and a first magnetic element are disposed in the upper chamber, while a second magnetic element and a coil set are disposed in the lower chamber. With this arrangement, the cost of the present invention is reduced while the safety thereof is improved.

In order to achieve the above objects, the present invention provides a faucet assembly, which includes a faucet body, a power-generating device, and a circuit board. The faucet body has a water channel. An accommodating chamber is provided in the water channel. An illumination port is provided below the faucet body. The power-generating device is provided in the accommodating chamber of the faucet body and has an impeller, a first magnetic element, a second magnetic element and a coil set. The impeller is connected to the first magnetic element. The second magnetic element is connected to the coil set. The first magnetic element and the second magnetic element attract each other to generate a mutual movement. The circuit board is electrically connected to the coil set of the power-generating device. The circuit board is arranged with light-emitting diodes corresponding to the illumination port of the faucet body. With this arrangement, the faucet assembly of the present invention is capable of providing enhanced illumination and a cleaning effect in a power-saving, durable and user-friendly manner, thereby increasing the practicability, novelty and inventive steps thereof.

In order to further understand the characteristics, features and technical contents of the present invention, a detailed description relating thereto will be made with reference to the accompanying drawings. However, the drawings are illustrative only, and should not be used to limit the scope of the present invention.

### BRIEF DESCRIPTION OF THE DRAWINGS

FIG. 1 is a perspective view according to a first embodiment of the present invention;

FIG. 2 is an exploded perspective view showing a power-generating device according to the first embodiment of the present invention;

FIG. 3 is a partial cross-sectional view according to the first embodiment of the present invention;

FIG. 4 is a schematic view showing the operating state according to the first embodiment of the present invention; and

FIG. 5 is a partial cross-sectional view according to a second embodiment of the present invention.

### DETAILED DESCRIPTION OF THE INVENTION

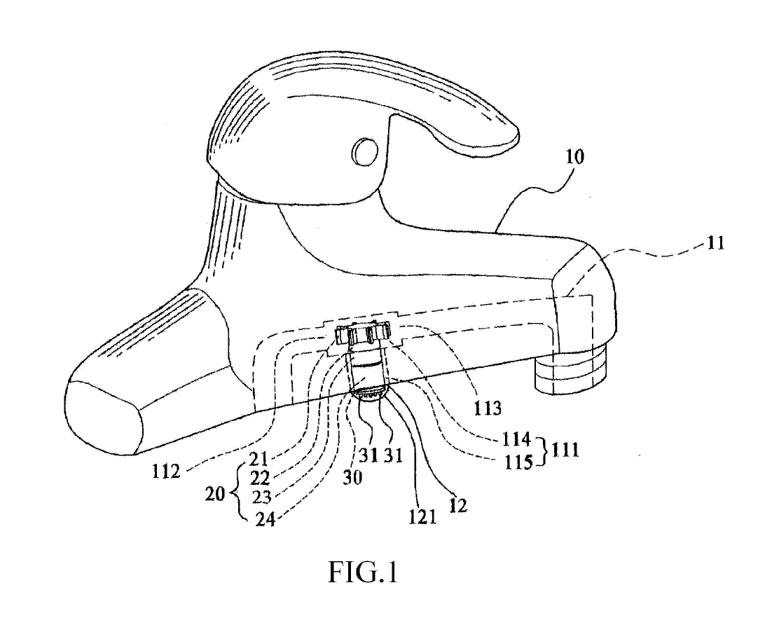

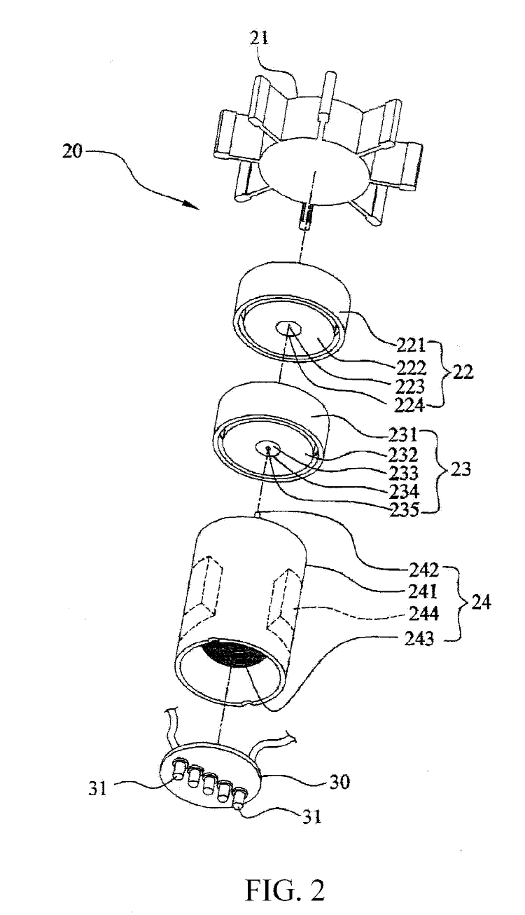

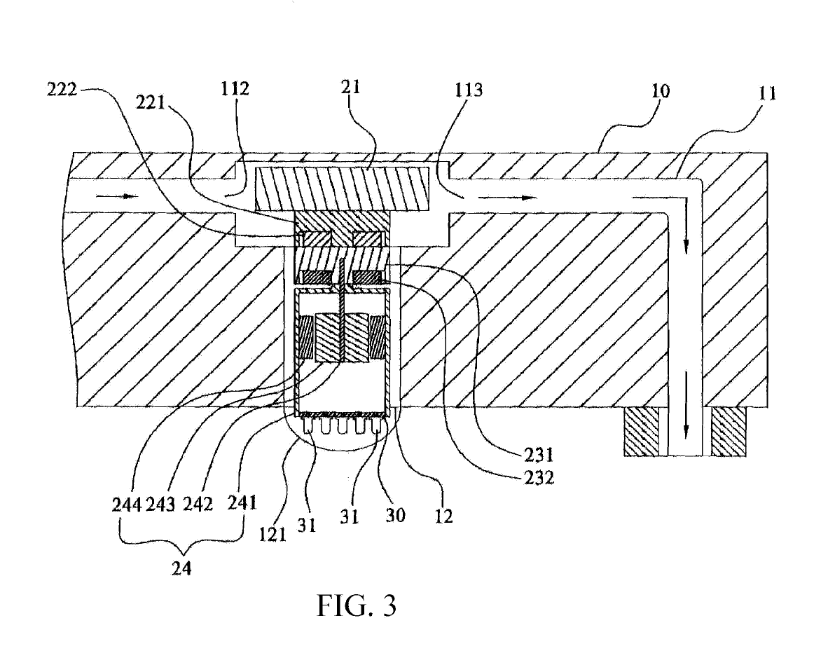

Please refer to FIGS. 1 to 3. FIG. 1 is a perspective view according to a first embodiment of the present invention, FIG. 2 is an exploded perspective view showing a power-generating device according to the first embodiment of the present invention, and FIG. 3 is a partial cross-sectional view according to the first embodiment of the present invention. The present invention provides a faucet assembly including a faucet body 10, a power-generating device 20 and a circuit board 30.

The faucet body 10 has a water channel 11. An accommodating chamber 111 is provided in the water channel 11. Both sides of the accommodating chamber 111 are provided with a water inlet 112 and a water outlet 113 respectively. The water inlet 112 and the water outlet 113 are in communication with the water channel 11 of the faucet body 10. In the present embodiment, the accommodating chamber 111 includes an upper chamber 114 and a lower chamber 115. The upper chamber 114 is separated from the lower chamber 115. The water inlet 112 and the water outlet 113 are provided on both sides of the upper chamber 114 respectively. Further, the water inlet 112 and the water outlet 113 are in communication with the water channel 11 of the faucet body 10. An illumination port 12 is provided below the faucet body 10. The illumination port 12 further includes a transparent shroud 121 for protecting the elements within the accommodating chamber 111.

The power-generating device 20 is provided in the accommodating chamber 111 of the faucet body 10. The power-generating device 20 is positioned to be perpendicular to the water channel 11 of the faucet body 10. The power-generating device 20 is provided sequentially with an impeller 21, a first magnetic element 22, a second magnetic element 23, and a coil set 24. The impeller 21 is connected to the first magnetic element 22. In the present embodiment, the impeller 21 is adhered to a first shell 221 of the first magnetic element 22. In practice, the impeller 21 may be integrally formed with the first shell 221 of the first magnetic element 22. The second magnetic element 23 is connected to the coil set 24. The first magnetic element 22 and the second magnetic element 23 attract each other to generate a mutual movement. The impeller 21 and the first magnetic element 22 are provided in the upper chamber 114 of the faucet body 10. The second magnetic element 23 and the coil set 24 are provided in the lower chamber 115 of the faucet body 10. The first magnetic element 22 and the second magnetic element 23 are separated by a predetermined distance and attract each other to generate a mutual movement. The first magnetic element 22 includes a first shell 221 and a first magnet 222. The second magnetic element 23 includes a second shell 231 and a second magnet 232. The first shell 221 has a first shaft 223. The center of the first magnet 222 is provided with a first hole 224, so that the first magnet 222 can be disposed on the first shaft 223 of the first shell 221. The second shell 231 has a second shaft 233. The center of the second magnet 232 is provided with a second hole 234, so that the second magnet 232 can be disposed on the second shaft 233 of the second shell 231. The second shaft 233 is provided with a pivotal hole 235. The coil set 24 of the power-generating device 20 includes a casing 241, a pivoting rod 242, a coil 243 and two magnets 244. The pivoting rod 242 is disposed in the casing 241. One end of the pivoting rod 242 protrudes from the casing 241 to be pivotally connected into the pivotal hole 235 of the second shaft 233 of the second shell 231. The coil 243 surrounds the pivoting rod 242. The two magnets 244 are disposed on two opposite inner sides of the casing 241 to be separated from the coil 243.

The circuit board 30 is electrically connected with the coil set 24 of the power-generating device 20. In the present embodiment, the electrical connection between the circuit board 30 and the coil set 24 is achieved by wires. In practice, electrical conductive pieces or other conductors may be used to achieve the electrical connection. The circuit board 30 is arranged thereon with light-emitting diodes 31 corresponding to the illumination port 12 of the faucet body 10.

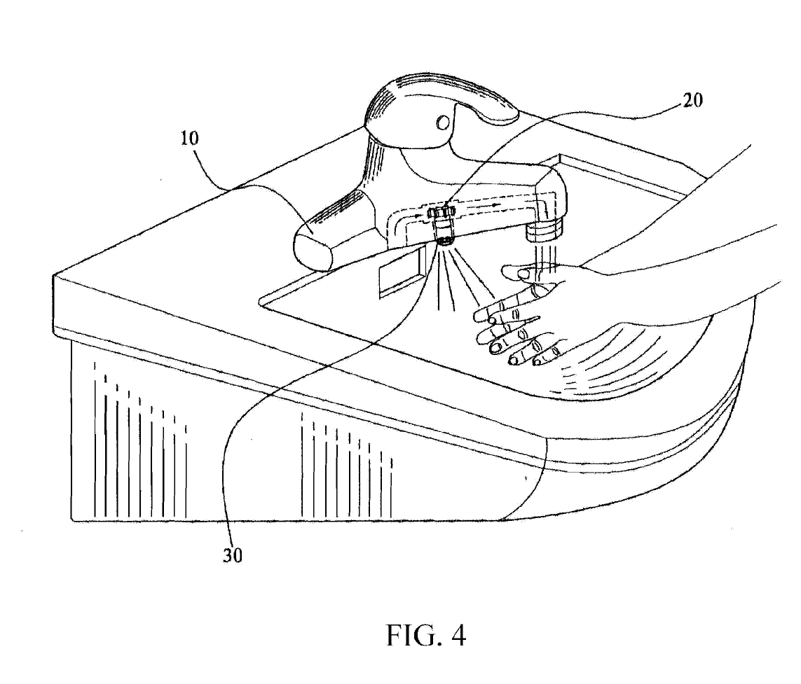

Please refer to FIGS. 1 to 4. When the user turns on the faucet body 10, the water flows through the water channel 11 of the faucet body 10, enters the accommodating chamber 111 through the water inlet 112, and finally exits the accommodating chamber 111 via the water outlet 113. Since the power-generating device 20 is positioned to be perpendicular to the water channel 11 of the faucet body 10, the flowing water drives the impeller 21 of the power-generating device 20 to rotate, thereby facilitating the rotation of the impeller 21. The first magnetic element 22 is connected to the impeller 21, so that the first magnetic element 22 can rotate together with the impeller 21. The second magnetic element 23 and the first magnetic element 22 are attracted to each other to generate a mutual movement. Since one end of the pivoting rod 242 of the coil set 24 is pivotally connected into the pivotal hole 235 of the second shaft 233 of the second shell 231, the pivoting rod 242 can move together with the second magnetic element 23, thereby causing the rotation of the coil set 243 surrounding the pivoting rod 242. At this time, an electric current is induced between the rotating coil set 243 and the two magnets 244 located on opposing two inner sides of the casing 241. The electric current is conducted to the circuit board 30 electrically connected to the coil set 24 of the power-generating device 20, thereby lighting up the light-emitting diodes 31 on the circuit board 30. The light emitted from the light-emitting diodes 31 illuminates the outside of the faucet body 10 via the illumination port 12. The faucet assembly of the present invention provides an enhanced cleaning effect because it can illuminate the objects to be cleaned. Since the present invention utilizes the light-emitting diodes 31 as a light source, the present invention is saves power and durable. The upper chamber 114 and the lower chamber 115 are separated from each other. The impeller 21 and the first magnetic element 22 of the power-generating device 20 are disposed in the upper chamber 114 of the faucet body 10. The second magnetic element 23 and the coil set 24 are disposed in the lower chamber 115 of the faucet body 10. With this arrangement, the coil set 24 may not suffer damage due to the flowing water. Thus, the lifetime of the present invention may be increased.

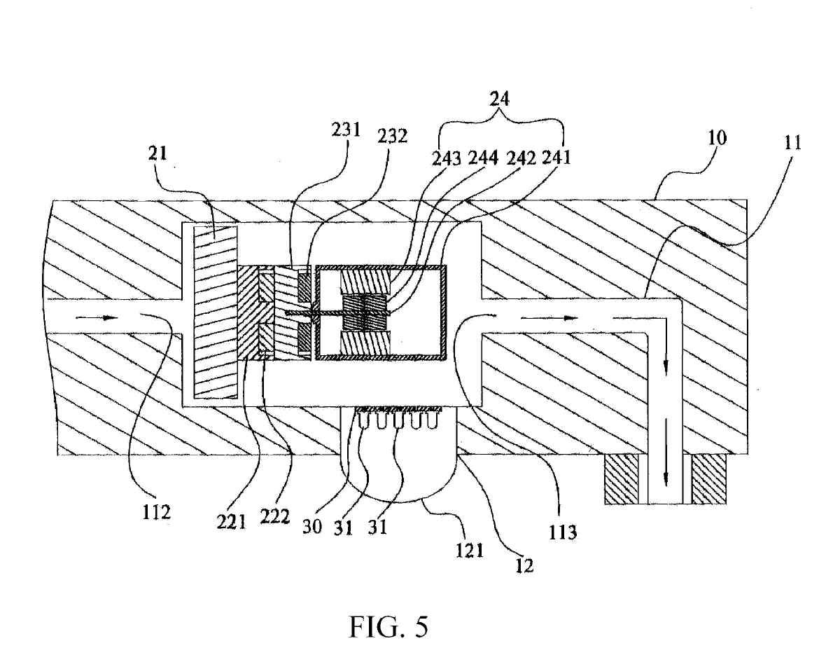

Please refer to FIGS. 2 and 5. FIG. 2 is an exploded perspective view showing the power-generating device of the first embodiment of the present invention, and FIG. 5 is an enlarged cross-sectional view of a second embodiment of the present invention. The faucet assembly of the present embodiment includes a faucet body 10, a power-generating device 20 and a circuit board 30.

The faucet body 10 has a water channel 11. An accommodating chamber 111 is provided in the water channel 11. Both sides of the accommodating chamber 111 are provided with a water inlet 112 and a water outlet 113 respectively. The water inlet 112 and the water outlet 113 are in communication with the water channel 11 of the faucet body 10. Further, the water inlet 112 and the water outlet 113 are in communication with the water channel 11 of the faucet body 10. An illumination port 12 is provided below the faucet body 10. The illumination port 12 further includes a transparent shroud 121 for protecting the elements within the accommodating chamber 111.

The power-generating device 20 is provided in the accommodating chamber 111 of the faucet body 10. The power-generating device 20 is positioned to be parallel with the water channel 11 of the faucet body 10. The power-generating device 20 is provided sequentially with an impeller 21, a first magnetic element 22, a second magnetic element 23, and a coil set 24. The impeller 21 is connected to the first magnetic element 22. In the present embodiment, the impeller 21 is adhered to a first shell 221 of the first magnetic element 22. In practice, the impeller 21 may be integrally formed with the first shell 221 of the first magnetic element 22. The second magnetic element 23 is connected to the coil set 24. The first magnetic element 22 and the second magnetic element 23 attract each other to generate a mutual movement. The first magnetic element 22 includes a first shell 221 and a first magnet 222. The second magnetic element 23 includes a second shell 231 and a second magnet 232. The first shell 221 has a first shaft 223. The center of the first magnet 222 is provided with a first hole 224, so that the first magnet 222 can be disposed on the first shaft 223 of the first shell 221. The second shell 231 has a second shaft 233. The center of the second magnet 232 is provided with a second hole 234, so that the second magnet 232 can be disposed on the second shaft 233 of the second shell 231. The second shaft 233 is provided with a pivotal hole 235. The coil set 24 of the power-generating device 20 includes a casing 241, a pivoting rod 242, a coil 243 and two magnets 244. The pivoting rod 242 is disposed in the casing 241. One end of the pivoting rod 242 protrudes from the casing 241 to be pivotally connected into the pivotal hole 235 of the second shaft 233 of the second shell 231. The two magnets 244 are disposed on two opposite inner sides of the pivoting rod 242. The coil 243 surrounds the pivoting rod 242. The two magnets 244 are separated from each other.

The circuit board 30 is electrically connected with the coil set 24 of the power-generating device 20. In the present embodiment, the electrical connection between the circuit board 30 and the coil set 24 is achieved with wires. In practice, electrical conductive pieces or other conductors may be used to achieve the electrical connection. The circuit board 30 is arranged thereon with light-emitting diodes 31 positioned corresponding to the illumination port 12 of the faucet body 10.

When the user turns on the faucet body 10, the water flows through the water channel 11 of the faucet body 10, enters the accommodating chamber 111 through the water inlet 112 to, and finally exits the accommodating chamber 111 via the water outlet 113. The flowing water drives the rotation of the impeller 21 of the power-generating device 20 to rotate. The first magnetic element 22 is connected to the impeller 21, so that the first magnetic element 22 can rotate together with the impeller 21. The second magnetic element 23 and the first magnetic element 22 attract each other to generate a mutual movement. Since one end of the pivoting rod 242 of the coil set 24 is pivotally connected into the pivotal hole 235 of the second shaft 233 of the second shell 231, the pivoting rod 242 can move together with the second magnetic element 23, thereby causing the rotation of the coil set 243 provided on two opposing sides of the pivoting rod 242. At this time, an electric current is induced between the two rotating magnets 244 and the coil set 243 surrounding the pivoting rod 242. The electric current is conducted to the circuit board 30 electrically connected to the coil set 24 of the power-generating device 20, thereby lighting up the light-emitting diodes 31 on the circuit board 30. The light emitted from the light-emitting diodes 31 illuminates the outside of the faucet body 10 via the illumination port 12. The faucet assembly of the present invention provides an enhanced cleaning effect because it can illuminate the objects to be cleaned. Since the present invention utilizes the light-emitting diodes 31 as a light source, the present invention saves power and is durable.

The faucet assembly of the present invention has the following advantageous features. The power-generating device 20 is provided in the accommodating chamber 111 of the faucet body 10. The power-generating device 20 is electrically connected to the circuit board 30. The circuit board 30 is arranged thereon with light-emitting diodes 31. Therefore, the present invention provides enhanced illumination and a cleaning effect in a power-saving, durable and user-friendly manner, thereby increasing the practicability, novelty and inventive steps thereof.

The accommodating chamber 111 of the faucet body 10 includes an upper chamber 114 and a lower chamber 115. The upper chamber 114 and the lower chamber 115 are separated from each other. The impeller 21 and the first magnetic element 22 of the power-generating device 20 are disposed in the upper chamber 114 of the faucet body 10. The second magnetic element 23 and the coil set 24 are disposed in the lower chamber 115 of the faucet body 10. With this arrangement, the coil set 24 may avoid damage due to the flowing water. Thus, the lifetime of the present invention may be increased.

The above disclosed embodiment is merely a preferred embodiment of the present invention. Various equivalent variations and modifications may be designed as known to those skilled in the art in view of the teachings of the present invention. Thus, all such variations and equivalent modifications are also embraced within the scope of the invention as defined in the appended claims.

What is claimed is:

1. A faucet assembly, including:
a faucet body having a water channel, an accommodating chamber disposed in the water channel, an illumination port provided below the faucet body;
a power-generating device provided in the accommodating chamber of the faucet body, the power-generating device having an impeller, a first magnetic element, a second magnetic element and a coil set, the impeller being connected to the first magnetic element, the second magnetic element being connected to the coil set, the first magnetic element and the second magnetic element attracting each other to generate a mutual movement; and
a circuit board electrically connected to the coil set of the power-generating device, the circuit board arranged with light-emitting diodes disposed corresponding to the illumination port of the faucet body.

2. The faucet assembly according to claim 1, wherein the power-generating device is positioned to be parallel with the water channel of the faucet body, the power-generating device provided sequentially from left to right with an impeller, a first magnetic element, a second magnetic element and a coil set, the first magnetic element and the second magnetic element attracting each other to generate a mutual movement.

3. The faucet assembly according to claim 1, wherein the power-generating device is positioned to be perpendicular to the water channel of the faucet body, the power-generating device provided sequentially from top to bottom with an impeller, a first magnetic element, a second magnetic element and a coil set, the first magnetic element and the second magnetic element attracting each other to generate a mutual movement.

4. The faucet assembly according to claim 3, wherein the accommodating chamber includes an upper chamber and a lower chamber, the upper chamber separated from the lower chamber, the water inlet and the water outlet provided on both sides of the upper chamber respectively, the water inlet and the water outlet in communication with the water channel of the faucet body, and one end of the lower chamber is in communication with the outside of the faucet body.

5. The faucet assembly according to claim 4, wherein the impeller and the first magnetic element are provided in the upper chamber of the faucet body, the second magnetic element and the coil set are provided in the lower chamber of the faucet body, the first magnetic element and the second magnetic element are separated by a predetermined distance and attract each other to generate a mutual movement.

6. The faucet assembly according to claim 1, wherein the first magnetic element includes a first shell and a first magnet, the second magnetic element includes a second shell and a second magnet, the first shell has a first shaft, the center of the first magnet is provided with a first hole for allowing the first magnet to be disposed on the first shaft of the first shell, the second shell has a second shaft, and the center of the second magnet is provided with a second hole for allowing the second magnet to be disposed on the second shaft of the second shell.

7. The faucet assembly according to claim 6, wherein the coil set of the power-generating device includes a casing, a pivoting rod, a coil and two magnets, the pivoting rod is disposed in the casing, one end of the pivoting rod protrudes from the casing to be pivotally connected into the pivotal hole of the second shaft of the second shell, the coil surrounds the pivoting rod, and the two magnets are disposed on two opposite inner sides of the casing to be separated from the coil.

8. The faucet assembly according to claim 6, wherein the coil set of the power-generating device includes a casing, a pivoting rod, a coil and two magnets, the pivoting rod is disposed in the casing, one end of the pivoting rod protrudes from the casing to be pivotally connected into the pivotal hole of the second shaft of the second shell, the two magnets are disposed on two opposite sides of the pivoting rod, and the coil surrounds the pivoting rod to be separated from the two magnets.

9. The faucet assembly according to claim 1, wherein the impeller and the first shell of the first magnetic element are integrally formed together.
